(19) United States
(12) Patent Application Publication
(10) Pub. No.: US 2021/0341009 A1
(43) Pub. Date: Nov. 4, 2021

(54) Functional Element

(71) Applicant: PROFIL Verbindungstechnik GmbH & Co. KG, Friedrichsdorf (DE)

(72) Inventors: Oliver Diehl, Usingen (DE); Tobias Jene, Friedrichsdorf (DE); Amer Mahlme, Bad Homburg (DE); Christian Sowa, Muhlheim/Main (DE)

(21) Appl. No.: 17/233,640

(22) Filed: Apr. 19, 2021

(30) Foreign Application Priority Data
Apr. 29, 2020 (DE) 102020111696.9

(51) Int. Cl. F16B 37/06

(52) U.S. Cl. CPC F16B 37/068

(57) ABSTRACT

The present invention relates to a self-punching functional element that is configured for punching into a workpiece, comprising a head part forming a flange; and a punching section that extends away from the head part, and that has a peripheral punching edge, wherein the head part has a contact surface for contact with the workpiece, said contact surface at least sectionally surrounding the punching section at a radial outer side, and a boundary section that at least sectionally bounds the contact surface at the radial outer side and that extends away from the contact surface in the same direction as the punching section. The invention further relates to a component assembly comprising a self-punching functional element, and a workpiece.

The present invention relates to a self-punching functional element that is configured for punching into a workpiece, in particular into a sheet metal part. The element comprises a head part forming a flange; and a punching section that extends away from the head part, that is in particular arranged coaxially to a central longitudinal axis of the functional element, and that has a peripheral punching edge.

In the field of the connection elements or functional elements that are mechanically attached to workpieces, such as sheet metal parts, on the production thereof, a distinction is made between force fitting elements, on the one hand, and rivet elements, on the other hand. Force fitting elements are characterized in that they are at least not intentionally deformed on attachment to a workpiece, but that the workpiece itself is deformed and brought into engagement with shape features of the force fitting element, whereby the force fitting element is fastened to the sheet metal part in a manner secure against being pressed out. With rivet elements, the element is intentionally deformed on the attachment to the sheet metal part, usually to form a rivet bead, whereby the sheet metal part is captured between the rivet bead and a flange part in order also here to achieve a connection secure against being pressed out.

Both force fitting elements and rivet elements are furthermore known as self-punching elements. The designation self-punching is to be understood such that the corresponding element punches its own hole into the workpiece in the course of the fastening process. The force required for this purpose is, for example, generated by a press, by a robot, or by a power-operated pair of tongs. In this respect, the self-punching element is pressed against the workpiece while the latter is supported on a corresponding die at the side remote from the element. Self-punching elements are associated with cost advantages since the workpiece does not have to be pre-punched.

Functional elements of the previously described kind are inter alia used—but by far not only used—in automotive engineering. With the expansion of the areas of use of such functional elements, the requirements they have to meet also increase.

There is therefore a need for self-punching functional elements that can be reliably fastened to a workpiece in a simple manner and that cope with high pressing-out forces or tensile forces as well as torques.

Such a functional element is provided by the present invention. Provision is made in accordance with the invention that the head part has a contact surface for contact with the workpiece, said contact surface at least sectionally surrounding the punching section at a radial outer side, and a boundary section that at least sectionally bounds the contact surface at the radial outer side and that extends away from the contact surface in the same direction as the punching section. The boundary section is in particular continuous in the peripheral direction. An inner wall of the boundary section facing the punching section and an outer wall of the punching section facing the boundary section are arranged at least sectionally obliquely to the longitudinal axis of the functional element so that the inner wall and the outer wall each form an undercut in at least one plane including the longitudinal axis.

The inner wall, the contact surface, and the outer wall so-to-say form a ring space that has undercuts due to the inner wall and outer wall being arranged at least sectionally obliquely with respect to the longitudinal axis and that is therefore suitable for forming a form fit with the material of the workpiece that is pressed into the ring space in the fastening process.

In this connection, the term “oblique” is also to be understood as an at least sectionally curved design of said walls. Due to the at least sectionally provided undercuts both at the inner wall and at the outer wall, a particularly good resistance capability against a pressing out or a pulling out of the element is achieved. The undercuts do not necessarily have to be continuous in the peripheral direction. It may be sufficient in many embodiment examples if at least a respective one peripheral segment of the outer wall and of the inner wall each forms an undercut. The two peripheral segments are in particular disposed opposite one another viewed in the radial direction.

The outer wall preferably has an undercut that is continuous in the peripheral direction, whereas the inner wall has a plurality of undercut segments that are in particular distributed in a uniform manner.

Further embodiments of the invention are set forth in the description, in the drawings, and in the claims.

In accordance with an embodiment, the inner wall has a polygonal contour in an axial end face view, which brings about an improved security against rotation of the element. This means that a fastened element can withstand larger torques since a form fit effective in the peripheral direction can be established between the workpiece and the element.

An improvement in the security against rotation is also achieved when the boundary section has an axial end face that faces the workpiece and whose inner edge and/or outer edge has/have a polygonal contour in an axial end face view.

The boundary section can have an axial end face that faces the workpiece and whose plane is disposed between a plane spanned by the contact surface and a plane spanned by the punching edge. The three planes are in particular arranged in parallel with one another.

The head part and/or the punching section preferably has/have a circular basic shape viewed in the axial direction—i.e. viewed in a plane perpendicular to the longitudinal axis. However, different basic shapes are also conceivable, for instance an oval, rectangular or polygonal basic shape. The punching edge and/or the outer wall of the punching section in particular has/have a polygonal contour in an axial end face view. In specific applications, it can be advantageous if the head part and the punching section have different basic shapes.

The above-explained, large geometric design freedom of the inner wall and outer wall as well as of the punching edge, inner edge and outer edge has the result that the ring space can have a complex shape. Therefore, in the context of the present invention, the meaning of this term is not to be restricted to a circular ring alone.

To further improve the security against rotation, the outer wall and/or the inner wall and/or the contact surface and/or the axial end face can be provided with at least one feature providing security against rotation, in particular with at least one elevated portion and/or recess extending in an axial direction and/or a radial direction. The number, positioning, and shape of the features can be selected as required.

For example, at least one rib extends from the inner wall toward the punching section in the radial direction and extends away from the contact surface in the axial direction, in particular wherein an axial extent of the rib decreases from the outside to the inside. The rib can extend up to the punching section. However, it is also possible for the rib to span only a portion of the spacing between the boundary section and the punching section or of the ring space (for example, less than 80%, less than 70%, less than 60%, or less than 50% of the spacing). The end face of the rib can have a rounded shape to minimize its notch effect and thus to not reduce the fatigue resistance of the workpiece in the region of the element.

Additionally or alternatively, at least one base that extends away from the contact surface in the axial direction can extend from the outer wall toward the boundary section in the radial direction. The base can extend up to the boundary section. However, it is also possible for the base to only span a portion of the spacing between the boundary section and the punching section or of the ring space (for example, less than 80%, less than 70%, less than 60%, or less than 50% of the spacing). The base can have a substantially planar end face that is arranged perpendicular or inclined to the longitudinal axis. The base not only serves to improve the security against rotation, but also assists the displacement and distribution of the material of the workpiece pressed into the ring space in the fastening process. An advantageous consequence is, among other things, the improvement in the tightness of the connection between the element and the workpiece.

The rib and the base can be arranged offset in a peripheral direction of the contact surface. A plurality of ribs and bases are in particular provided that are arranged uniformly distributed in the peripheral direction and that are arranged offset from one another. An alternating arrangement of ribs and bases, which preferably overlap in the radial direction, provides particularly good results with respect to a reliability and tightness of the connection between the element and the workpiece.

In accordance with an embodiment, the functional element is a nut element that has a bore having an internal thread. The functional element can also be a bolt element that has a bolt section extending from the head part at a side remote from the punching section, in particular wherein the bolt section is at least sectionally provided with an external thread.

The present invention further relates to a component assembly comprising a functional element in accordance with at least one of the previously described embodiments; and a workpiece, in particular a sheet metal part, wherein the workpiece is at least partly urged into a ring space, which is formed by the inner wall, the contact surface and the outer wall, and into the undercuts in a region around a hole punched out by the punching section so that the functional element is connected in a form-fitted manner to the workpiece.

In accordance with an embodiment of the component assembly, a side of the workpiece remote from the contact surface is provided with a recess that is continuous or segmented in the peripheral direction, in particular a ring recess, in a region adjacent to the hole or directly adjacent to the hole. The material of the workpiece in the region of the recess is in particular at least partly arranged in the ring space. The geometric basic shape of the recess is preferably complementary to that of the ring space. However, it can also deviate therefrom. The recess is in particular rotationally symmetrical.

The recess can be produced in the course of the fastening process of the element to the workpiece, e.g. by a die that presses material of the workpiece, which is adjacent to the hole produced by the punching section, into the ring space.

On the manufacture of the component assembly, the element has to be coordinated with the thickness and design of the workpiece in the region of the hole to be produced. The length of the punching section, that is its axial extent from the head part, is advantageously smaller than the depth of the recess in many cases. In other words, in this embodiment of the component assembly, an axial extent of the punching section is selected such that the punching section does not project from the recess in order to obtain a component assembly that is as compact as possible. It is thus inter alia ensured that a planar fastening plane is present on the side of the workpiece remote from the head part of the functional element.

Provision can also be made that the thickness of the workpiece in the region of the hole substantially corresponds to or is smaller than the axial extent of the punching section in order to simplify the punching of the hole. However, it is also possible for the workpiece to have a thickness that is greater than the axial extent of the punching section.

If the functional element has ribs and bases that provide security against rotation, a component assembly is produced by the attachment of said functional element to a workpiece, said component assembly being characterized in that both the ribs and the bases are in form-fitted engagement with the workpiece. In other words, the workpiece extends in a form-fitted manner into the ring space in that it extends around the ribs and bases and engages behind the undercuts. Furthermore, the material engaging around the punching section and/or engaging into the undercut, i.e. the material in the region of the wall of the hole in the workpiece, presses substantially elastically against the punching section, wherein a compressive ring stress is present in the workpiece material around the punching section. The corresponding stranglehold between the workpiece material and the punching section results in a high-quality fatigue resistance of the join connection.

The component assembly is preferably formed by means of a die having a ring nose such that the side of the workpiece remote from the head part of the element is provided with a ring recess extending around the punching edge. This ring recess, which is produced by the ring nose of the die, is inter alia important when the workpiece has a thickness that is greater than the axial extent of the punching section. The recess then namely ensures that the workpiece is completely punched through by the punching section. For example, the punching section is shorter than the workpiece thickness by an amount of up to 0.04 mm, preferably up to 0.02 mm.

Preferred embodiments of the functional element in accordance with the invention or of the corresponding component assembly can be seen from the dependent claims and from the still following description of examples with reference to the enclosed drawings. They show:

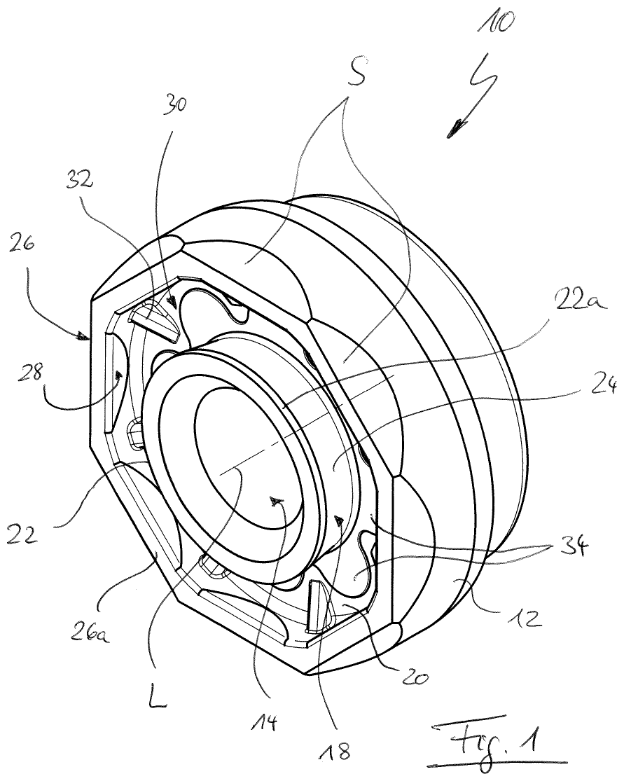

FIG. 1 a perspective view of an embodiment of the functional element in accordance with the invention;

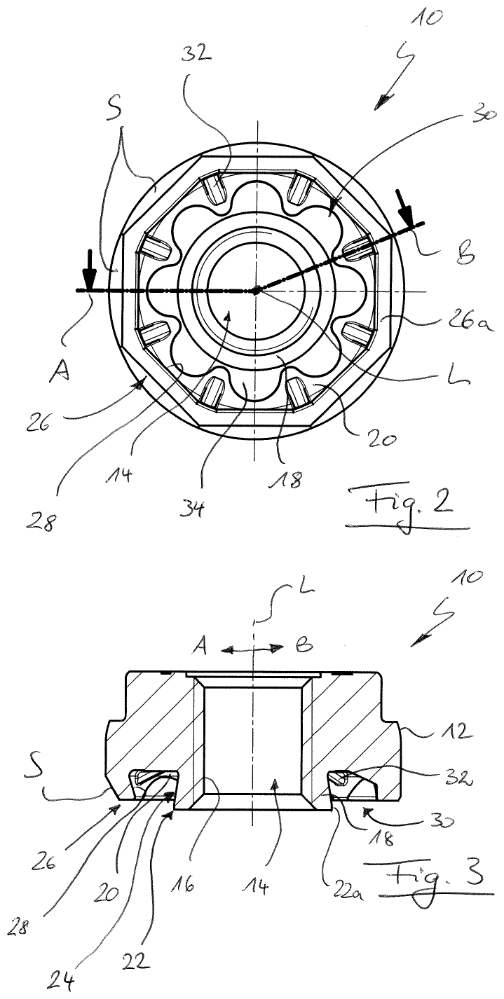

FIG. 2 an end face view of the functional element in accordance with FIG. 1;

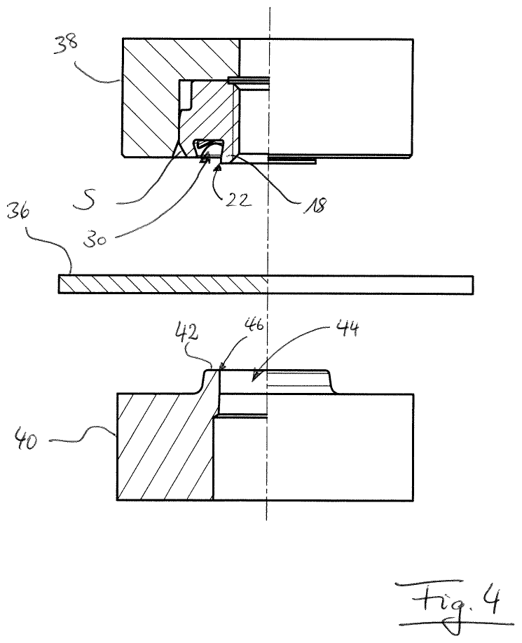

FIG. 3 a sectional view of the functional element in accordance with FIG. 1;

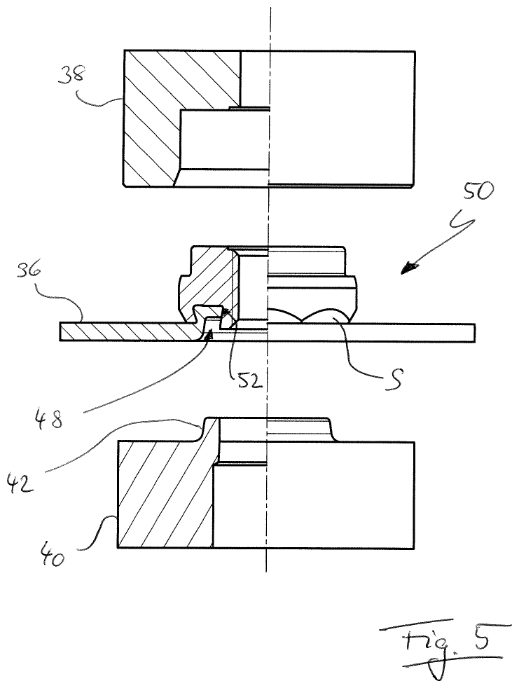

FIGS. 4, 5 an embodiment of a fastening process for fastening the functional element in accordance with FIG. 1 to a workpiece; and

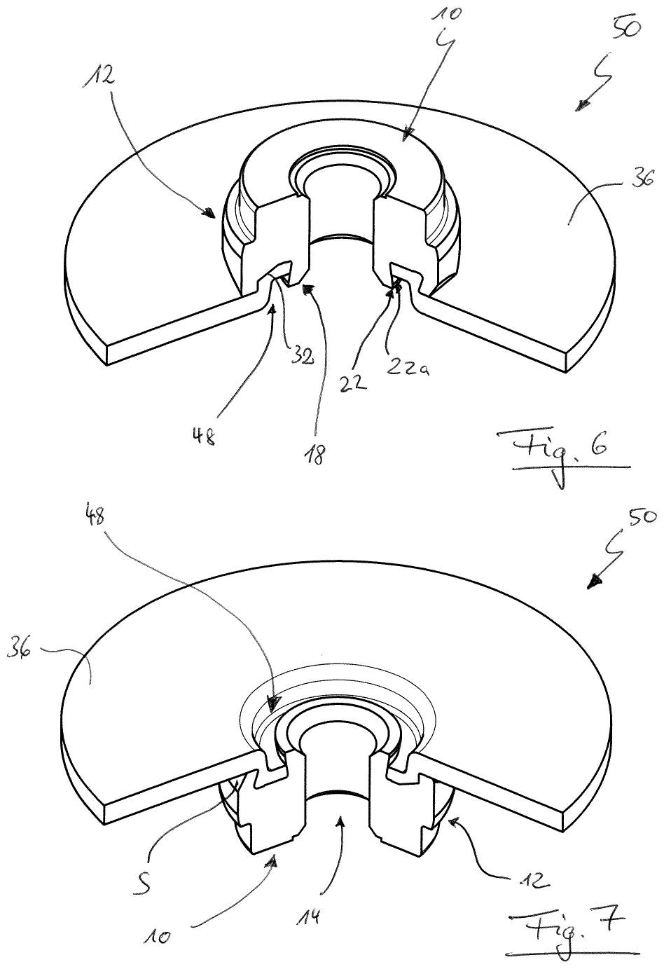

FIGS. 6, 7 the component assembly obtained by the fastening process in a part section.

FIGS. 1 to 3 show an embodiment of a nut element 10 in a perspective view, in an end face view, and in a sectional view in two sectional planes A, B whose position is indicated in FIG. 2. Said nut element 10 is configured for fastening to a sheet metal part. The element 10 has a head part 12 that forms a flange for contact with a workpiece. Said element 10 comprises a central bore 14 along a longitudinal axis L having an internal thread 16. Instead of the bore 14, an element designed in accordance with the invention can also be a bolt element in which a bolt extends from the head part 12.

The element 10 is a self-punching force fitting element. It obtains its self-punching property from a punching section 18 that extends away from a sheet metal contact surface 20 of the head part 12. The punching section 18 has a peripheral punching edge 22 that cooperates with a die, which will still be described in the following, to punch a hole into the sheet metal part (or into any other desired workpiece) that receives the section 18. As can in particular be seen from FIG. 3, an outer wall 24 of the section 18 is not arranged completely in parallel with the longitudinal axis L. Only a section 22a directly adjacent to the punching edge 22 extends in parallel in order to stabilize the punching edge 22. The outer wall 24 is arranged obliquely between the section 22a and the sheet metal contact surface 20 so that it forms an undercut, by which the element 10 can be fixed to the sheet metal part, opposite a press-in direction of the element 10. The margin of the hole produced by the section 18 namely engages behind this undercut and thus secures the element 10 to the sheet metal part. The angle between the inclined section of the outer wall 24 and the longitudinal axis amounts to a few degrees, in particular to less than 15°, preferably to less than 10°. On the manufacture of the element 10, the undercut can be produced by an axial squeezing of an originally cylindrical punching section.

To improve the fixing, the element 10 has a margin 26 that is continuous in the peripheral direction and that bounds the contact surface 20 at the radially outer side. The margin 26 comprises an inner wall 28 that faces the punching section 18 and that is arranged at least sectionally obliquely to the longitudinal axis L. The wall 28 thus sectionally likewise forms an undercut that increases the resistance to being pressed out or the resistance to being pulled out. The angle between the inclined section of the inner wall 28 and the longitudinal axis amounts to a few degrees. In the present embodiment, the angle is greater than that angle between the inner wall 24 and the longitudinal axis L. The margin 26 also has an axial end face 26a that is arranged in parallel with the sheet metal contact surface 20 and that is disposed on the sheet metal part in an assembled state of the element 10.

The walls 24, 28 and the sheet metal contact surface 20 define a ring space 30 into which material of the sheet metal part is pressed on the pressing in of the element 10, whereby a form fit acting in the axial direction is produced. A form fit that acts in the radial direction and that secures the element 10 against a rotation by torques acting on it is produced by a number of features.

On the one hand, the inner wall 28 of the margin 26 does not have an annular design, but rather a polygonal design. This shape is achieved in a simple manner by a sectional radially inward pressing in of the margin 26 that is circular in an intermediate state during the manufacturing process of the element 10—a cold impact process. In the present embodiment, eight segments S have been urged inwardly. The number of segments S can be adapted to the respective application, if necessary. Due to the processing of the margin 26, its end face 26a has a polygonal shape overall, i.e. both an inner edge and an outer edge of the end face 26a have a polygonal contour.

On the other hand, ribs 32 and bases 34 extend from the inner wall 28 or the outer wall 24 into the ring space 30 in the radial direction. They are uniformly distributed and arranged offset in the peripheral direction. Due to their radial extent of more than 50% of the ring space width, they overlap in the peripheral direction so that a particularly good security against rotation effect results.

The ribs 32 are in communication with inner wall sections that are not inclined radially inwardly (see section B in FIG. 3). These sections were not pressed inwardly during the manufacture since adjacent segments S adjoin one another here.

In the present embodiment, an upper edge of the ribs 32 extending from the contact surface 20 is rounded and is designed sloping down radially inwardly. In an assembled state of the element 10, the ribs 32 dig into the material of the sheet metal part pressed into the ring space 30.

The bases 34 each have a substantially planar surface that is arranged in parallel with the sheet metal contact surface 20. It is also conceivable to design the surface as sectionally or completely inclined and/or curved. The bases 34, which extend only slightly from the contact surface 20 in the axial direction in comparison with the ribs 32, in particular bring about a displacement and thus an advantageous distribution of the material of the workpiece pressed into the ring space 30. Therefore, they not only contribute to an improvement in the security against rotation, but also to an improvement in the tightness of the connection of the element 10 to the workpiece.

FIG. 4 shows the process of fastening the element 10 to a sheet metal part 36 that is not pre-punched. The element 10 is arranged in a recess of a setting device 38. The punching section 18 projects slightly from this recess. On the fastening, the sheet metal part 36 is disposed on a die 40 that has a ring nose 42. The ring nose 42 has a central recess 44 that is bounded by a die edge 46. The edge 46 and the punching edge 22 ultimately bring about the separation of a slug from the sheet metal part 36 when the element 10 is pressed against the sheet metal part 36 by the setting device 38 with a sufficiently large force. The slug is led away downwardly.

In the setting process, the ring nose 42 has the effect that the sheet metal part 36 is pressed into the ring space 30 in the region around a punched-out hole 52, as can be clearly seen in FIG. 5. The material of the sheet metal part 36 is in this respect urged behind undercuts of the walls 24, 28. The material of the sheet metal part 36 is distributed by the ribs 32 projecting into the ring space 30 and in particular by the bases 34 such that a reliable form fit is produced between the element 10 and the sheet metal part 36 that is active both in the axial direction and in the peripheral direction of the element 10. The element 10 and the sheet metal part 36 now form a component assembly 50 (see FIG. 5).

FIGS. 6 and 7 each show the component assembly 50 in a perspective view from obliquely above or from obliquely below. A part segment has been cut out to illustrate the character of the connection between the element 10 and the sheet metal part 36. The part of the section at the left in FIG. 6 extends through a rib 32 (as also in the section B in FIGS. 2 and 3), whereby the sloping downward of its upper edge in the radial direction is recognizable.

It can likewise be seen from FIG. 6 that the punching section 18 does not project from the ring recess 48 produced. Thus, it does not impede a closely contacting fastening of a further workpiece to the sheet metal part 36.

In FIG. 7, the ring recess 48 of circular ring shape can be recognized that was produced by the ring nose 42. The geometric basic shape of the ring recess 48 is indeed not formed completely complementary to that of the ring space 30 since the latter is bounded at the radial outer side by the polygonal inner wall 28.

However, due to the features 32, 34 providing security against rotation and the shape of the ring nose 42, the material of the sheet metal part 36 is sufficiently well distributed in the ring space 30.

### REFERENCE NUMERAL LIST

10 nut element
12 head part
14 bore
16 internal thread
18 punching section
20 sheet metal contact surface
22 punching edge
22a punching edge section
24 outer wall
26 margin
38A end face
28 inner wall
30 ring space
32 rib
34 base
36 sheet metal part
38 setting device
40 die
42 ring nose
44 recess
46 die edge
48 ring recess
50 component assembly
52 hole
A, B sectional plane
L longitudinal axis
S segment

1. A self-punching functional element that is configured for punching into a workpiece, the self-punching functional element comprising
a head part forming a flange; and
a punching section that extends away from the head part, and that has a peripheral punching edge,
wherein the head part has a contact surface for contact with the workpiece, said contact surface at least sectionally surrounding the punching section at a radial outer side, and a boundary section that at least sectionally bounds the contact surface at the radial outer side and that extends away from the contact surface in the same direction as the punching section; and
wherein an inner wall of the boundary section facing the punching section and an outer wall of the punching section facing the boundary section are arranged at least sectionally obliquely to the longitudinal axis of the functional element so that the inner wall and the outer wall each form an undercut in at least one plane including the longitudinal axis.

2. The self-punching functional element in accordance with claim 1,
wherein the self-punching functional element is configured for punching into a sheet metal part.

3. The self-punching functional element in accordance with claim 1,
wherein the punching section is arranged coaxially to a central longitudinal axis of the functional element.

4. The self-punching functional element in accordance with claim 1,
wherein the inner wall has a polygonal contour in an axial end face view.

5. The self-punching functional element in accordance with claim 1,
wherein the boundary section has an axial end face that faces the workpiece, and wherein at least one of an inner edge of the axial end face and an outer edge of the axial end face has a polygonal contour in an axial end face view.

6. The self-punching functional element in accordance with claim 1,
wherein the boundary section has an axial end face that faces the workpiece and wherein a plane of the axial end face is disposed between a plane spanned by the contact surface and a plane spanned by the punching edge.

7. The self-punching functional element in accordance with claim 6,
wherein the plane of the axial end face, the plane spanned by the contact surface and the plane spanned by the punching edge are arranged in parallel with one another.

8. The self-punching functional element in accordance with claim 1,
wherein at least one of the punching edge and the outer wall of the punching section has a circular or a polygonal contour in an axial end face view.

9. The self-punching functional element in accordance with claim 1,
wherein the boundary section has an axial end face that faces the workpiece and wherein at least one of the outer wall, the inner wall, the contact surface and the axial end face is provided with at least one feature providing security against rotation.

10. The self-punching functional element in accordance with claim 9,
wherein the at least one feature providing security against rotation is at least one elevated portion and/or recess extending in an axial direction and/or a radial direction.

11. The self-punching functional element in accordance with claim 1,
wherein at least one rib extends from the inner wall toward the punching section in the radial direction and extends away from the contact surface in the axial direction.

12. The self-punching functional element in accordance with claim 11,
wherein an axial extent of the rib decreases from the outside to the inside.

13. The self-punching functional element in accordance with claim 1,
wherein at least one base extends from the outer wall toward the boundary section in the radial direction and extends away from the contact surface in the axial direction.

14. The self-punching functional element in accordance with claim 11,
wherein at least one base extends from the outer wall toward the boundary section in the radial direction and extends away from the contact surface in the axial direction and
wherein the rib and the base are arranged offset in a peripheral direction of the contact surface.

15. The self-punching functional element in accordance with claim 14,
wherein a plurality of ribs and bases are provided that are arranged uniformly distributed in the peripheral direction and that are arranged offset from one another.

16. The self-punching functional element in accordance with claim 1,
wherein the functional element is a nut element that has a bore having an internal thread.

17. The self-punching functional element in accordance with claim 1,
wherein the functional element is a bolt element that has a bolt section extending from the head part at a side remote from the punching section.

18. The self-punching functional element in accordance with claim 17,
wherein the bolt section is at least sectionally provided with an external thread.

19. A component assembly comprising a self-punching functional element, and a workpiece, the self-punching functional element comprising
a head part forming a flange; and
a punching section that extends away from the head part, and that has a peripheral punching edge,
wherein the head part has a contact surface for contact with the workpiece, said contact surface at least sectionally surrounding the punching section at a radial outer side, and a boundary section that at least sectionally bounds the contact surface at the radial outer side and that extends away from the contact surface in the same direction as the punching section; and
wherein an inner wall of the boundary section facing the punching section and an outer wall of the punching section facing the boundary section are arranged at least sectionally obliquely to the longitudinal axis of the functional element so that the inner wall and the outer wall each form an undercut in at least one plane including the longitudinal axis wherein the workpiece is at least partly urged into a ring space, which is formed by the inner wall, the contact surface and the outer wall, and into the undercut in a region around a hole punched out by the punching section so that the functional element is connected in a form-fitted manner to the workpiece.

20. The component assembly in accordance with claim 19,
wherein a side of the workpiece remote from the contact surface is provided with one of a recess and a ring recess in a region adjacent to the hole or directly adjacent to the hole.

21. The component assembly in accordance with claim 19,
wherein an axial extent of the punching section is selected such that it does not project from the recess.

22. The component assembly in accordance with claim 19,
wherein the thickness of the workpiece in the region of the hole substantially corresponds to or is smaller than the axial extent of the punching section.
